(19) United States
(12) Patent Application Publication
(10) Pub. No.: US 2021/0242759 A1
(43) Pub. Date: Aug. 5, 2021

(54) Electric Insulation System of an Electric Motor, and Associated Manufacturing Process

(71) Applicant: Siemens Aktiengesellschaft, München (DE)

(72) Inventors: Tobias Katzenberger, Bad Königshofen STT Untereßfeld (DE); Bastian Plochmann, Neustadt an der Aisch (DE)

(73) Assignee: Siemens Aktiengesellschaft, München (DE)

(21) Appl. No.: 17/052,770

(22) PCT Filed: May 3, 2019
(86) PCT No.: PCT/EP2019/061442

§ 371 Date: Nov. 3, 2020

(30) Foreign Application Priority Data
May 4, 2018 (EP) 18170757.1

(51) Int. Cl. H02K 15/12; H02K 3/30; H02K 3/34; H02K 15/10; B29C 44/12

(52) U.S. Cl. CPC H02K 15/12; H02K 3/30; B29K 2105/046; H02K 15/105; B29C 44/1209; H02K 3/34

(57) ABSTRACT

Various embodiments of the teachings herein include an electrical insulation system for an electric motor comprising a conductor with wire winding in a slot of a laminated core of a stator. The wire winding is embedded in an encapsulation. The encapsulation includes volume-increasing particles.

### CROSS-REFERENCE TO RELATED APPLICATIONS

This application is a U.S. National Stage Application of International Application No. PCT/EP2019/061442 filed May 3, 2019, which designates the United States of America, and claims priority to EP Application No. 18170757.1 filed May 4, 2018, the contents of which are hereby incorporated by reference in their entirety.

### TECHNICAL FIELD

The present disclosure relates to electric motors. Various embodiments comprise improved electrical insulation systems for electric motors and/or production methods for improved electrical insulation system for electric motors.

### BACKGROUND

Laminated cores of electric motors typically comprise slots having a wire winding, generally a copper wire winding, wherein the wire is electrically insulated by means of a wire enamel. Depending on the size and power classes, there are different possibilities here for manufacturing electric motors. With a shaft height in the order of magnitude of 63 mm to 450 mm, and in accordance with the powers of 150W to 1.6 MW, the so-called stator, that is to say the laminated core, is typically equipped with prewound wire windings. Here, these windings are mechanically introduced into the stator slots and then connected up. The electrical insulation of the individual wires with respect to one another and with respect to the laminated core at ground potential is provided by means of surface insulation materials, such as paper, and the wire enamel of the individual winding wires.

On account of the geometric requirements of the slots, such as the slot tooth, which serves to form magnetic field lines which are as closed as possible, a maximum slot filling of 85% by volume with winding wire, surface insulation material, including wire enamel, is possible since otherwise, for example, the drawing-in forces would be excessive and hence the surface insulation and/or the wire enamel could be damaged, for example by scratches, cracks and/or by elongation. As a result, at least 15% by volume of free volume remains in the slots of the laminated core. A part thereof is exposed because the winding does not fill the corners of the slot in an accurately fitting manner, but existing cavities within the winding are filled as completely as possible with impregnating resin in the impregnating process.

Unfortunately, it has been shown that considerable gaps exist here because, upon withdrawing the stator from the dip bath, the impregnating resin is often still so liquid that insufficient filling of the cavities occurs here also inside the conductor, that is to say the wire winding. For this purpose, it is generally the case that, in a dip method, one or more stators are dipped slowly into a liquid impregnating resin tray such that the liquid impregnating resin can flow into the cavities between the individual wires, the slot and the laminated core and can fill these cavities. Subsequently, the thus impregnated stators are cured over a certain time period through the action of temperature and/or UV irradiation. As a result, the liquid and/or gelled impregnating resin, which in the dip bath fills the remaining cavities of the slots in the volume which is still hollow after the wire winding, produces the finished encapsulation, for example in the form of a completely cured thermoset as encapsulating compound.

The as complete as possible filling of the cavities with encapsulating compound is thus particularly so important because the heat dissipation of the wire winding, the mechanical fixing with respect to vibrations, the partial discharge resistance with respect to the laminated core and/or the passivation against dust and/or moisture of the laminated core and of the conductor is ensured only by as complete as possible filling with encapsulation.

However, a complete filling of the interspaces is not possible with conventional methods, such as for example dip impregnation, and the required manufacturing variance in which impregnating resin and dip methods are not optimized to one stator type but are set to an average value over all types which are impregnated on this manufacturing line. There actually still remain cavities and defects, for instance as a result of back-flowing impregnating resin and/or impregnating resin which does not flow in properly, because for example the viscosity in the dip bath has not been set low enough.

Nor is it possible in the dip bath for the aforementioned properties of the impregnating resin to be optimized by admixing specific additives in the form of particular fillers. Such additives would be for example mica platelets for increasing the partial discharge resistance, quartz flour, aluminum oxide and/or boron nitride for increasing the thermal conductivity.

Given the increasing viscosity and/or the settling behavior in the dip bath, it is not possible by means of a dip bath method for any additives to be introduced into the impregnating resin which later forms the encapsulation of the conductor in the insulation system. In dip impregnation and also in other impregnating methods such as vacuum impregnation, spray impregnation, etc., of stators, it is usually as a result of insufficient impregnating resin take-up that defects arise in the electrical insulation system EIS that form cavities in relatively large gaps.

It is particularly as a result of so-called “random winding”, which generates a disturbed arrangement between slot liner and laminated core, that there are created such defects which have the effect of disproportionately reducing the mechanical fixing of the winding wires in the encapsulation, because the winding wires, some of which are several centimeters long, have no fixing and are thus susceptible to mechanical harmonics of the motor. This frequently ends during operation in breakages of the electrical metal lines, in particular the copper lines, which are situated in the winding wires below the insulating wire enamel. Moreover, such large-area defects are quasi open-pore and thus susceptible to dust, metallic abrasion and moisture, with the result that the performance of the motor and ultimately also its service life are adversely affected.

To date, the impregnating resins have been further developed in a costly manner to the effect that thixotropy of the impregnating resin is performed in the dip bath, that is to say the impregnating resin liquefies upon immersing the stators as a result of shear thinning and then remains at a higher viscosity in the slot. Moreover, the impregnating resin has a very narrow gelling range in order to flow completely into the slot but then to reliably gel, but at the same time to optimally flow off again at the somewhat colder outer side of the laminated core, since the resin is rather obstructive here. The stators are sometimes preheated here in order, upon immersion, to utilize the effect of the temperature-induced viscosity reduction. The precrosslinking—also referred to as gelling—in the conductor itself here requires a process time of several minutes.

The manufacturing processes of dip impregnation is generally tailored to many different stator variants in terms of resin, speed and/or temperature, with the result that only an average value is created, or the impregnating resin in the dip bath is over dimensioned for some few demanding stators. Consequently, dip impregnation is on average frequently associated over all stator variants with areal defects, which leads to the above-specified drawbacks, such as very low thermal conductivity and/or hot spots as a result of air gaps, partial discharges in large air-filled gaps, mechanical loading of wires which are not fixed over large areas, and moisture ingress/dust, as illustrated in FIG. 1, which shows the prior art. These problems can only be minimized and not prevented by optimized parameter setting of the dip impregnation and a highly developed impregnating resin, which is highly developed particularly in terms of its gel point.

### SUMMARY

The teachings of the present disclosure include a targeted filling of the slots of a stator with an impregnating resin which is suitable for the motor type and which in particular also comprises additives and/or fillers. For example, some embodiments include an electrical insulation system EIS of an electric motor, comprising at least one conductor with wire winding in a slot of a laminated core of a stator, characterized in that the wire winding in the conductor is embedded in an encapsulation in which volume-increasing particles are present.

In some embodiments, the conductor comprises, in addition to the winding wires, at least one carrier for supplying the wire winding with impregnating resin.

In some embodiments, the encapsulation comprises fillers.

In some embodiments, the encapsulation comprises mica particles as filler.

In some embodiments, the encapsulation comprises aluminum oxide particles as filler.

In some embodiments, the encapsulation comprises boron nitride particles as filler.

In some embodiments, the carrier comprises fibers.

In some embodiments, the volume-increasing particles comprise gas-filled particles.

In some embodiments, the encapsulation comprises additives.

In some embodiments, the encapsulation comprises an epoxy resin.

In some embodiments, the encapsulation is substantially free of macropores.

As another example, some embodiments include a method for producing an electrical insulation system EIS of an electric motor, comprising the following method steps: forming a conductor from winding wire and carrier medium loaded with filled impregnating resin, drawing the formed conductor into the slots of a laminated core of a stator of the electric motor, heating the laminated core at a temperature and speed such that gas-filled particles present in the impregnating resin expand with an increase in volume in such a way that they increase the volume of the not yet cured impregnating resin, and curing the impregnated winding wire carrier insulation.

In some embodiments, fibers in the form of prepreg fibers are used as carrier medium.

### BRIEF DESCRIPTION OF THE DRAWINGS

The functioning of the expanding particles is schematically illustrated below on the basis of the figures, in which:

FIGS. 1 and 2 are drawings depicting winding wires surrounded by wire enamel forming, together with prepreg fibers, a conductor.

### DETAILED DESCRIPTION

Some embodiments of the teachings herein include an electrical insulation system EIS of an electric motor, comprising at least one conductor having winding wire in a slot of a laminated core of a stator, characterized in that the wire winding in the conductor is embedded in an encapsulation in which volume-increasing particles are present.

Some embodiments include a method for producing an electrical insulation system EIS of an electric motor, the methods comprising:
forming a conductor from winding wire and carrier medium loaded with filled impregnating resin,
drawing the formed conductor into the slots of a laminated core of a stator of the electric motor,
heating the laminated core at a temperature and speed such that gas-filled particles present in the impregnating resin expand with an increase in volume in such a way that they increase the volume of the not yet cured impregnating resin, and
curing the impregnated winding wire carrier insulation.

In some embodiments, a carrier medium, such as for example a fiber or a fiber composite, can firstly be integrated without problems into the winding process for producing the wire winding, secondly can be loaded with sufficient content of impregnating resin in order thus to provide the complete synthetic resin encapsulation for an electrical insulation system of an electric motor, and thirdly, upon loading the carrier medium, a filled impregnating resin can be used, with the result that any desired fillers and/or additives can be introduced into the slot insulation through the targeted introduction of an impregnating resin by means of carrier medium.

The “carrier medium” or “impregnating resin carrier” used in the present disclosure may include prepreg fibers, alone or in combination with further carriers. Further carriers in this sense can be sponges and/or foams, for example.

The “conductor” refers in the present disclosure to a bundle of winding wires which are wound together and form a bundle of winding wires which is drawn into a slot of a laminated core.

In some embodiments, the impregnating resin filled with volume-increasing particles expands during the production of the finished EIS, with the result that a fixed ratio of wire to carrier volume in the winding or in the conductor can be determined here only in the finished electric motor. Since a volume increase of the winding already situated in the slot is assumed as a result of the expansion, it is also possible in the finished EIS that a % by volume of more than 40% by volume can be demonstrated in the conductor as a result of the impregnating resin within the wire winding.

In some embodiments, the prepreg fibers are concomitantly wound simultaneously with the bundling of the winding wires, in particular the copper wires, and are thus present between the winding wires in the conductor therewith in the winding and in the finished electric motor.

In some embodiments, the number of prepreg fiber windings in relation to the winding wire windings is here selected to be so low as necessary in order not to waste any space in the slot that would be able to be filled with winding wire. Accordingly, the number of prepreg fiber windings and the size of the prepreg fiber volumes in the voltage field is selected to be high enough to ensure that the stator core after curing is saturated as completely as possible and low enough as possible to ensure that the volume filling level in the slot with line material, in particular with conductive winding wire, e.g. with copper wire, does not suffer as a result. By virtue of introducing the impregnating resin to produce the EIS, it is very simply possible here, depending on the motor type, to bring about a wide-ranging variation in the winding through addition/reduction of the concomitantly wound prepreg fibers.

In some embodiments, long and/or continuous fibers are present in the conductor with winding wire in a ratio of 1 fraction by volume of fiber to 3 fractions by volume of winding wire. In some embodiments, the ratio of prepreg fiber to winding wire lies in the range from 1 to 3, as described above, up to 2 fractions by volume of prepreg fiber to 1 fraction by volume of winding wire, that is to say more prepreg fiber fractions than winding wire fractions in the conductor. The respective fractions depend for example on the absorbency of the fiber, that is to say the resin content per fraction by volume of fiber, the diameter of the fiber, etc.

In some embodiments, the targeted introduction of impregnating resin includes filling with volume-increasing fillers, such as for example gas-filled microcapsules which are commercially available, inter alia, from Akzo Nobel under the name Expancel®. In some embodiments, from 1 to 10% by weight of these volume-increasing particles are introduced into the liquid impregnating resin, which is also referred to as reaction resin, and loaded with this is the carrier medium by means of which the filled impregnating resin can be introduced into the slot insulation in a targeted manner. The loaded carrier medium and/or the loaded fiber are referred to for example as “filled semifinished product”.

Introducing for example between 2% by weight and 6% by weight, in particular between 3% by weight and 5% by weight, can bring about a volume increase of the carrier medium and/or of the impregnating resin volume by a factor of 2. Moreover, the loading of a carrier medium with filled impregnating resin makes it possible for further fillers, such as mica, aluminum oxide and boron nitride, to be introduced into the slot insulation in any desired filler fractions. Furthermore, the loading of a carrier medium with filled or unfilled impregnating resin makes it possible for various additives to be introduced into the encapsulation of the slot insulation.

In some embodiments, the impregnating resin used is a thermoset, such as an epoxy resin, Bakelite, crosslinkable polyurethane and/or polyester resin. In some embodiments, the impregnating resin is capable of having a B state. In this respect, the carrier used to introduce the impregnating resin into the conductor is loaded with the filled impregnating resin in the B state in order to bring the impregnating resin into the conductor. Subsequently, the conductor together with stator is heated such that the impregnating resin melts again and can be homogeneously distributed in the conductor. It is only after the homogeneous distribution of the impregnating resin in the conductor has occurred that the latter is heated to such an extent that complete through-curing of the impregnating resin results to give the final encapsulation.

The “B state of a resin” refers in the present disclosure to a resin, for example a thermoset, which—in particular at room temperature—is present in a state in which it is superficially gelled, possibly slightly tacky but not yet through-cured. This state is also referred to as preproduct and/or as prepolymer. This state of the prepolymer arises when the impregnating resin has been crosslinked only to a small extent but at the same time obtains a certain degree of stability at the surface, with the result that, although not solid and crosslinked, it is also no longer present in liquid form. In the B state, a thermoset can once again be melted and liquefied without breaking down.

In some embodiments, the carrier media used in the production of the conductor, that is to say the winding of the conductive winding wires insulated with wire enamel, are fibers which are used as prepreg fibers. The preimpregnation of a fiber for producing the prepreg fiber can be performed for example by dip impregnation of the fiber. Here, fibers are drawn through a dip bath which contains the impregnating resin, for example a filled and/or additive-containing impregnating resin, optionally diluted with a solvent. The as yet unloaded fiber is drawn through the dip bath at a predetermined speed, wherein the fiber receives for the first time impregnating resin at its surface and, depending on the absorbency of the fiber, also within the fiber, for example in open pores and/or braid or tangle cavities. After completing the pass through the dip bath, the preimpregnated fiber is dried and thus freed from solvent. Here, the B state of the impregnating resin is also generated in and on the fiber. It is possible for the fiber wetted with impregnating resin in the B state to be slightly tacky at the surface.

The thus impregnated and dried fiber is then referred to as “prepreg fiber”. It also falls under the term “semifinished product”. By contrast thereto, the fiber which has only a small residual content of impregnated resin, if any, is simply referred to as “fiber”.

Both figures depict the winding wires 1, each surrounded by wire enamel 2. As can be seen on the left in each case, the winding wires 1 form, together with the prepreg fibers 3, a bundle, i.e. the conductor 4. Here, the winding wires 1 are present in the conductor 4 with the same orientation, e.g. naturally parallel, or with approximately the same orientation, that is to say quasi-parallel.

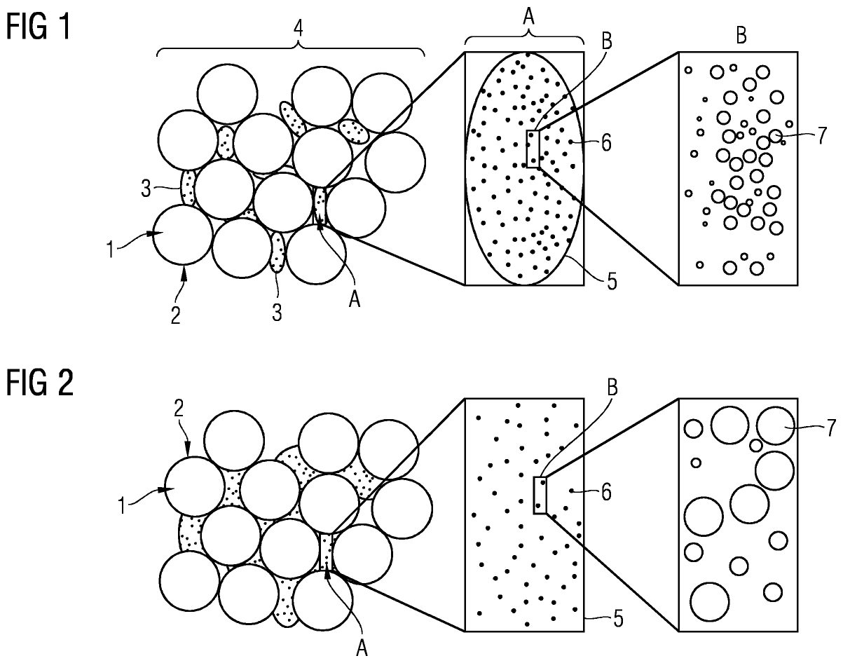

In the center of FIGS. 1 and 2 there is shown the detail A of the left-hand side of FIGS. 1 and 2, with the detail A being illustrated in greatly enlarged form. It can be seen in the respective central illustration here that fillers 6 are present in the impregnating resin 5 of the carrier medium, such as the prepreg fiber 3. On the far right of both FIGS. 1 and 2 there is in turn presented in enlarged form a detail B from the central illustration A. It can be seen here that the filler particles soften and expand as a result of an increase in volume at a defined temperature. There here sets in a foaming effect which has the effect of closing relatively large cavities and defects with impregnating resin. A functionally filled impregnating resin 3 in the B state has been used here that experiences an expansion starting from a certain curing temperature, with the result that cavities of the slot insulation that are present as a result of processing are filled by the swelling material. For this purpose, use can be made for example of expanding, thermoplastic hollow spheres such as those from Akzo Nobel, available under the tradename Expancel®.

It has been shown that, in addition to the more complete filling of the cavities, the thermal conductivity and the partial discharge resistance of the electrical insulation system EIS was able to be improved using precisely such particles. Tests were able to show that, given a corresponding temperature, even small amounts of the volume-increasing particle show a strong foaming effect with a volume increase by a multiple.

Further tests were able to demonstrate that twisted prepreg fibers with copper conductors show a considerable volume increase already prior to complete curing, in the B state. It was thus possible for a slot insulation which is fundamentally free from macroscopically observable pores to be repeatedly produced. The individual winding wires are driven apart by foaming force and mechanically fixed in the encapsulation.

In some embodiments, there can be used functionally filled reaction and/or impregnating resins which can be introduced into the slot insulation via the loading of a carrier medium, such as a fiber, as prepreg fiber. These filled impregnating resins are not suitable for an impregnating method using a dip bath. In some embodiments, more than 50% by weight of quartz flour has additionally been introduced into the prepreg as well in order to increase the thermal conductivity of the microporous material.

Thus, in spite of the positive action of the foaming effect, no disadvantage results in the thermal conductivity at the otherwise air-enclosed hot spots which arise as a result of the dip impregnation method. Since the system is a closed-pore system, and since precisely the macroscopic “open pores” are closed by the foaming, passivation and mechanical fixing likewise result. Given otherwise identical dielectric properties of the plastic, the partial discharge resistance is also improved in the defective regions.

In some embodiments, in combination with the use of prepreg fibers as carrier medium for impregnating resin, use is made of thermally expandable impregnating resins and encapsulating materials which have better heat conduction and/or are more resistant to partial discharge and which would not be usable by means of dip impregnation. The service life and the performance of the motors are thus increased. Moreover, manufacturing costs are avoided by omitting the dip bath impregnating process.

In some embodiments, the cover slide and/or the slot liner and/or the bindings in the stator are preimpregnated with functional particles and/or functionally filled impregnating resins in order to further increase the impregnating resin quantity in the stator.

In some embodiments, the expansion sizes of the particles can be varied in order, where appropriate, to further increase the partial discharge resistance. Here, the expansion size may be chosen according to Paschen's equation, which states that partial discharges ignite only from a minimum pore size. Thus, a relatively small porosity deliberately introduced to increase the partial discharge resistance serves to prevent a relatively large porosity, such as that between the conductor and the slot corners. This is particularly also because the surface insulation material, that is to say for example the paper, is pressed into the slot corners upon volume increase and thus reduces the cavity between conductor and slot corner and hence the risk of partial discharges. In some embodiments, impregnation of a conductor-equipped laminated core is not performed by dip impregnation but by the targeted introduction of an impregnating resin, which is filled with volume-increasing particles, into the slots of the laminated core.

What is claimed is:

1. An electrical insulation system for an electric motor, the system comprising:
a conductor with wire winding in a slot of a laminated core of a stator;
wherein the wire winding is embedded in an encapsulation; and
the encapsulation includes volume-increasing particles.

2. The insulation system as claimed in claim 1, wherein the conductor comprises a carrier with an impregnating resin.

3. The insulation system as claimed in claim 1, wherein the encapsulation comprises a filler.

4. The insulation system as claimed in claim 1, wherein the encapsulation comprises mica particles.

5. The insulation system as claimed in claim 1, wherein the encapsulation comprises aluminum oxide particles.

6. The insulation system as claimed in claim 1, wherein the encapsulation comprises boron nitride particles.

7. The insulation system as claimed in claim 1, wherein the carrier comprises fibers.

8. The insulation system as claimed in claim 1, wherein the volume-increasing particles comprise gas-filled particles.

9. The insulation system as claimed in claim 1, wherein the encapsulation comprises additives.

10. The insulation system as claimed in claim 1, wherein the encapsulation comprises an epoxy resin.

11. The insulation system as claimed claim 1, wherein the encapsulation does not comprise macropores.

12. A method for producing an electrical insulation system for an electric motor, the method comprising:
forming a conductor from winding wire and a carrier medium loaded with filled impregnating resin;
drawing the formed conductor into the slots of a laminated core of a stator of the electric motor;
heating the laminated core such that gas-filled particles present in the impregnating resin expand with an increase in volume and thereby increase the volume of the not yet cured impregnating resin; and
curing the impregnated winding wire carrier insulation.

13. The method as claimed in claim 12, wherein the carrier medium comprises prepreg fibers.
